(19) United States
(12) Patent Application Publication
(10) Pub. No.: US 2026/0287813 A1
(43) Pub. Date: Sep. 24, 2026

(54) PHOTONIC INTEGRATED CIRCUITS FOR IMPLEMENTING NON-ABELIAN GAUGE FIELDS

(71) Applicant: Seoul National University R&DB Foundation, Seoul (KR)

(72) Inventors: Namkyoo Park, Seoul (KR); Sunkyu Yu, Seoul (KR); Gyunghun Kim, Seoul (KR); Xianji Piao, Seoul (KR)

(73) Assignee: Seoul National University R&DB Foundation, Seoul (KR)

(21) Appl. No.: 19/038,487

(22) Filed: Jan. 27, 2025

(30) Foreign Application Priority Data
Sep. 3, 2024 (KR) 10-2024-0119460
Oct. 24, 2024 (KR) 10-2024-0147067

(51) Int. Cl. G02B 6/122; G02B 6/12

(52) U.S. Cl. CPC G02B 6/122; G02B 2006/12147; G02B 2006/12159

(57) ABSTRACT

A photonic integrated circuit for implementing a non-abelian gauge field according to the present invention includes a unit element including a plurality of resonators, and a waveguide coupler configured to implement a coupling between the resonators, wherein the waveguide coupler includes a reciprocal phase shifter applied to one single waveguide among waveguides, a local non-reciprocal phase shifter applied to another single waveguide among the waveguides, and a global non-reciprocal phase shifter applied to all of the waveguides.

### CROSS-REFERENCE TO RELATED APPLICATION

This application claims priority to and the benefit of Korean Patent Application No. 10-2024-0119460, filed on Sep. 3, 2024, and Korean Patent Application No. 10-2024-0147067, filed on Oct. 24, 2024, the disclosures of which are incorporated herein by reference in their entirety.

### BACKGROUND

### 1. Field of the Invention

The present invention relates to a photonic integrated circuit for implementing a non-abelian gauge field.

### 2. Discussion of Related Art

By using quantum superposition and entanglement phenomena or the like, quantum computer technologies aim to provide new algorithms and hardware platforms that can solve problems that are impossible or difficult to solve with existing computers. In order to implement actually usable quantum computers, there has been an increasing need to implement devices, algorithms, and systems related to quantum computers. Among these, in particular, when large-scale quantum computations are performed using a large number of qubits, the key technology for commercializing quantum computers is to implement hardware platforms such as ion traps, superconductors, semiconductor qubits, and photonic systems used in quantum computers to be robust to defects such as classical or quantum signal noise and process errors. Topological quantum computing for topologically protecting quantum states has been proposed as a solution to such a problem.

For topological quantum computing, the implementation of reconfigurable non-abelian gauge fields is essential. In particular, topological quantum computers using light should be as general as possible to reconstruct non-abelian gauge fields in a programmable photonic integrated circuit and implement many types of SU(2) gauge fields and should be implemented in a form compatible with lattice structures.

### SUMMARY OF THE INVENTION

The present invention is directed to providing a photonic integrated circuit for implementing a non-abelian gauge field, which is as general as possible to reconstitute a non-abelian gauge field in a programmable photonic integrated circuit and implement many types of SU(2) gauge fields and is capable of implementing a gauge field in a form compatible with a lattice structure.

According to an aspect of the present invention, there is provided a photonic integrated circuit for implementing a non-abelian gauge field, the photonic integrated circuit including a unit element including a plurality of resonators, and a waveguide coupler configured to implement a coupling between the resonators, wherein the waveguide coupler includes a reciprocal phase shifter applied to one single waveguide among waveguides, a local non-reciprocal phase shifter applied to another single waveguide among the waveguides, and a global non-reciprocal phase shifter applied to all of the waveguides.

The reciprocal phase shifter, the local non-reciprocal phase shifter, and the global non-reciprocal phase shifter may be formed to have Mach-Zehnder interferometer structures linked to each other in series.

The reciprocal phase shifter may be formed to have a waveguide structure including a medium of which a refractive index is controllable.

The reciprocal phase shifter may be achieved using thermal-optical modulation, electro-optical modulation, or all-optical modulation.

The local non-reciprocal phase shifter may have distinct refractive indices according to a direction.

The local non-reciprocal phase shifter may be formed to have a waveguide structure including a non-reciprocal medium of which a refractive index is controllable through a magnetic field.

The global non-reciprocal phase shifter may have distinct refractive indices according to a direction.

The global non-reciprocal phase shifter may be formed to have a waveguide structure including a non-reciprocal medium of which the refractive index is controllable through a magnetic field.

Refractive indices of the reciprocal phase shifter, the local non-reciprocal phase shifter, and the global non-reciprocal phase shifter may be designed to implement a matrix expressing a non-abelian gauge field.

The resonator may be implemented as a traveling-wave resonator.

The traveling-wave resonator may be a microdisk or a ring resonator.

The resonator may have a resonance mode in which the resonator rotates clockwise and counterclockwise near an operating frequency.

The unit element may implement a braiding group used in topological quantum computing.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an exemplary diagram of a unit element of a photonic integrated circuit capable of reconfigurably implementing an arbitrary SU(2) gauge field according to one embodiment of the present invention;

FIG. 2 illustrates a configuration of a lattice using the unit element of FIG. 1 as a basic unit;

FIGS. 3A to 3C show diagrams illustrating a range of an implementable non-abelian gauge field and a phase shift value required therefor according to one embodiment of the present invention;

FIGS. 4A to 4C shows diagrams showing an example of a waveguide design for implementing a non-reciprocal phase shifter according to one embodiment of the present invention;

FIG. 5 is a diagram illustrating a lattice design technique for inducing desired topological characteristics in a lattice implemented based on a unit element according to one embodiment of the present invention;

FIGS. 6A to 6H shows diagrams illustrating various abelian and non-abelian topological medium states implemented through a lattice according to one embodiment of the present invention; and

FIGS. 7A to 7F shows diagrams illustrating implementation of programmable non-abelian braiding essential for a topological quantum computer according to one embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, embodiments of a photonic integrated circuit for implementing a non-abelian gauge field according to one embodiment of the present invention will be described. The accompanying drawings are not necessarily to scale and in some instances, proportions may have been exaggerated in order to clearly illustrate features of the embodiments. Further, the terms to be described below are terms defined in consideration of functions in the present invention and thus may vary according to intentions or customs of users and operators. Accordingly, the definitions of such terms should be made based on the content throughout the specification.

It should be understood that the present invention may be embodied in different ways and is not limited to the following embodiments. In the accompanying drawings, portions unrelated to the description will be omitted in order to obviously describe the present invention, and similar reference numerals will be used to describe similar portions throughout the present specification.

Throughout the specification, unless explicitly described to the contrary, the word “comprise” and variations such as “comprises” or “comprising” will be understood to imply the inclusion of stated elements but not the exclusion of any other elements.

Implementations described herein may be implemented in, for example, a method or process, an apparatus, a software program, a data stream, or a signal. Even when discussed only in the context of a single form of implementation (e.g., discussed only as a method), implementations of the discussed features may also be implemented in other forms (for example, an apparatus or a program). The apparatus may be implemented in suitable hardware, software, firmware, and the like. A method may be implemented in an apparatus such as a processor, which is generally a computer, a microprocessor, an integrated circuit, a processing device including a programmable logic device, or the like.

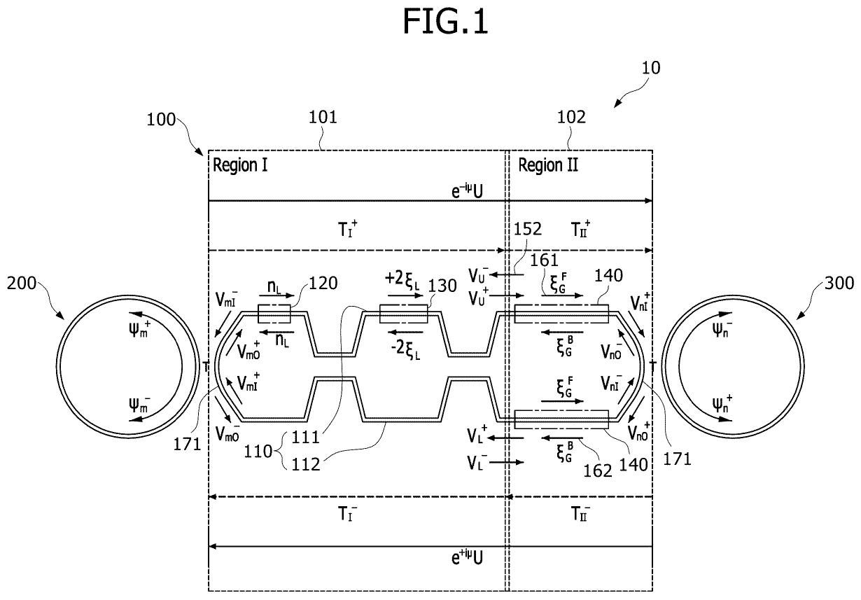

FIG. 1 is an exemplary diagram of a unit element of a photonic integrated circuit enabling the reconfigurable implementation of an arbitrary SU(2) gauge field according to one embodiment of the present invention.

Referring to FIG. 1, a unit element 10 of the photonic integrated circuit may implement an arbitrary SU(2) gauge field in a reconfigurable manner.

The unit element 10 of the photonic integrated circuit may include a waveguide coupler 100 and two resonators 200 and 300.

The resonators 200 and 300 may be implemented as traveling-wave resonators such as microdisks or ring resonators. In addition, the resonators 200 and 300 may have a resonance mode in which the resonators 200 and 300 rotate clockwise and counterclockwise near an operating frequency.

The waveguide coupler 100 may couple an m^{th} traveling-wave resonator 200 and an n^{th} traveling-wave resonator 300.

The waveguide coupler 100 may include a reciprocal phase shifter 120 applied to a first waveguide 111 among two waveguides 110, a local non-reciprocal phase shifter 130 applied to a second waveguide 112 among the waveguides 110, and a global non-reciprocal phase shifter 140 applied to both waveguides 110.

Here, the waveguide coupler 100 may be formed to have a Mach-Zehnder interferometer structure that serially links the reciprocal phase shifter 120, the local non-reciprocal phase shifter 130, and the global non-reciprocal phase shifter 140.

The reciprocal phase shifter 120 of the waveguide coupler 100 may be applied to the first waveguide 111 among the two waveguides 110. The reciprocal phase shifter 120 may be formed to have a waveguide structure including a medium of which a refractive index may be controlled through thermo-optical, electro-optical, or all-optical modulation.

A first arrow 151 of the waveguide coupler 100 may indicate a clockwise pseudospin resonance, and a second arrow 152 thereof may indicate a counterclockwise pseudospin resonance. A field inside the waveguide coupler 100 in which the counterclockwise pseudospin resonance and the clockwise pseudospin resonance interact with each other is also shown.

The local non-reciprocal phase shifter 130 may be applied only to the second waveguide 112 among the waveguides 110. The local non-reciprocal phase shifter 130 may be formed to have a waveguide structure including a non-reciprocal medium which has different refractive indices according to a direction like a Ce:YIG medium and of which a refractive index may be controlled through a magnetic field.

The global non-reciprocal phase shifter 140 may be applied to both waveguides 110. Here, a third arrow 161 and a fourth arrow 162 indicate forward and backward directions, respectively. The global non-reciprocal phase shifter 140 may be formed to have a waveguide structure including a non-reciprocal medium which has different refractive indices according to a direction like a Ce:YIG medium and of which a refractive index may be controlled through a magnetic field.

An m^{th} resonator 200 supports counterclockwise (ψₘ⁺) and clockwise (ψₘ⁻) resonance modes, which may be implemented as a pseudospin mode of a spinor state of Ψₘ=[ψₘ⁺, ψₘ⁻]\hat{ }T.

An n^{th} resonator 300 supports counterclockwise (ψₙ⁺) and clockwise (ψₙ⁻) resonance modes, which may be implemented as a pseudospin mode of a spinor state Ψₙ=[ψₙ⁺, ψₙ⁻]\hat{ }T.

The m^{th} resonator 200 and the n^{th} resonator 300 may be indirectly coupled through a waveguide loop 171. The waveguide loop 171 may be closely coupled to the m^{th} resonator 200 and the n^{th} resonator 300 to have a damping ratio of 1/τ.

A field inside the waveguide coupler 100 is coupled to a mode of the m^{th} resonator 200, which is denoted as v_{mI}⁺, v_{mO}⁺, v_{mI}⁻, Or v_{mO}⁻. Here, “+” and “−” denote pseudospins of coupled resonance modes, and “I” and “O” denote input and output couplings between the m^{th} resonator 200 and the n^{th} resonator 300. In addition, a spinor representation may be applied to the field of the waveguide coupler 100 to be expressed as V_{mI}=[v_{mI}+, v_{mI}⁻]\hat{ }T and V_{mO}⁻=[v_{mO}+, v_{mO}⁻]\hat{ }T.

The waveguide coupler 100 of FIG. 1 may include a first region 101 and a second region 102.

The first region 101 may include the reciprocal phase shifter 120 in an upper arm, the local non-reciprocal phase shifter, and a SU(2) gate up to a global phase including η_{L} and ±2ξ_{L}.

The local non-reciprocal phase shifter 130 is non-reciprocal for forward (+2ξ_{L}) propagation and backward (−2ξ_{L}) propagation.

The second region 102 may provide a global non-reciprocal phase shift (NRPS) to both waveguides 110 using ξ_{G}^{F} and ξ_{G}^{B} for forward propagation and backward propagation.

Here, refractive indices of the reciprocal phase shifter 120, the local non-reciprocal phase shifter 130, and the global non-reciprocal phase shifter 140 may be designed to implement a matrix expressing a non-abelian gauge field to be implemented.

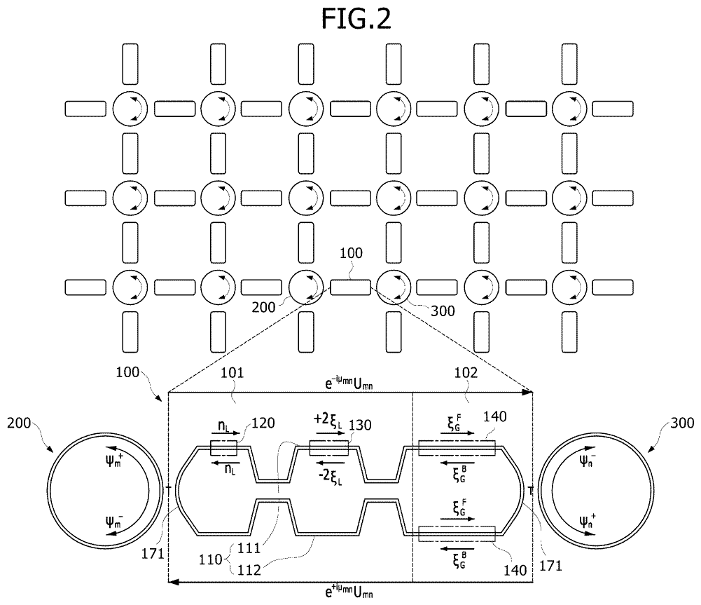

FIG. 2 illustrates a configuration of a lattice using the unit element of FIG. 1 as a basic unit.

The lattice using the unit element 10 as a basic unit may be guided to operate in a Hamiltonian and matrix-type gauge field as in Equation 1 below through coupled resonance mode analysis.

$$H = - \frac{1}{2 τ} {\sum }_{< m , n >} ( {\hat{a}}_{↑ m}^{†} {\hat{a}}_{↓ m}^{†} ) {e}^{i {μ}_{mn}} {U}_{mn}^{†} ( \begin{matrix}{\hat{a}}_{↑ n} \\ {\hat{a}}_{↓ n}\end{matrix} ) + H . c . \qquad [ Equation 1 ]$$

Here,

$$( {\hat{a}}_{↑ m}^{†} , {\hat{a}}_{↓ m}^{†} ) and ( {\hat{a}}_{↑ m} , {\hat{a}}_{↓ m} )$$

are creation and annihilation operator pairs of counterclockwise and clockwise pseudospin resonances at the mth lattice site, <m,n> denotes a pair of two adjacent indices, μₘₙ denotes a U(1) gauge field, H.c. denotes Hermitian conjugate, and Uₘₙ denotes a SU(2) connection variable tailored only by local phase shifts ξ_{L} and η_{L} and is represented by Equation 2 below.

$${U}_{mn} = [ \begin{matrix}{e}^{- \frac{1}{2} ( {η}_{L} + π )} sin {ξ}_{L} & {e}^{+ \frac{1}{2} ( {η}_{L} + π )} cos {ξ}_{L} \\ {e}^{- \frac{1}{2} ( {η}_{L} - π )} cos {ξ}_{L} & {e}^{+ \frac{1}{2} ( {η}_{L} + π )} sin {ξ}_{L}\end{matrix} ] \qquad [ Equation 2 ]$$

The unit element 10 presented in this way may implement a gauge field expressed by a SU(2) matrix value, thereby implementing a photonic integrated circuit capable of also implementing an arbitrary SU(2) non-abelian gauge field.

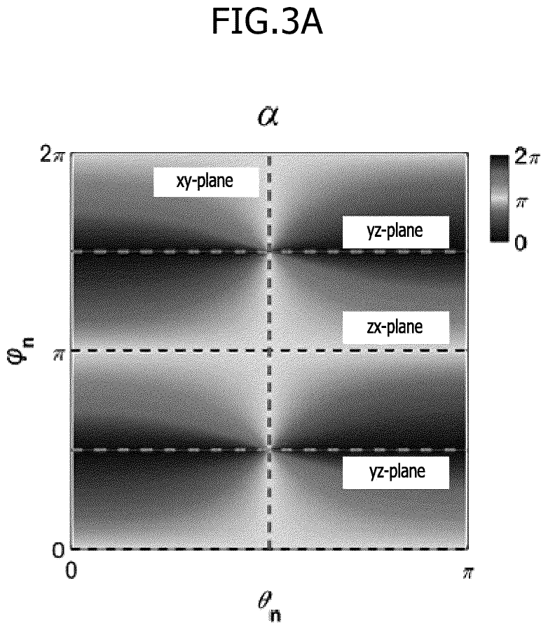

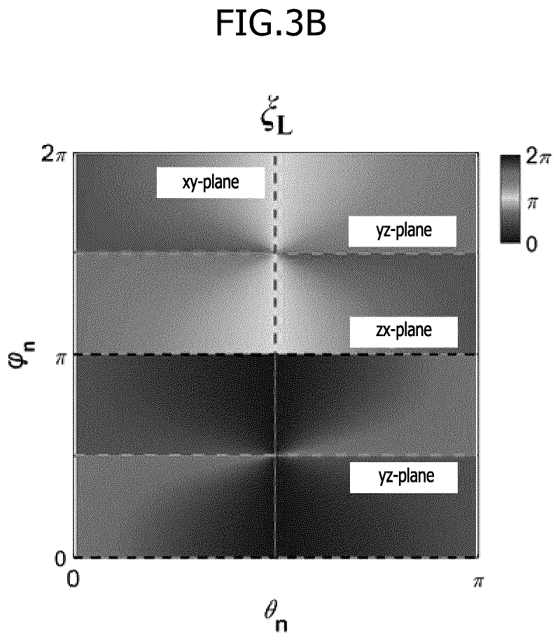

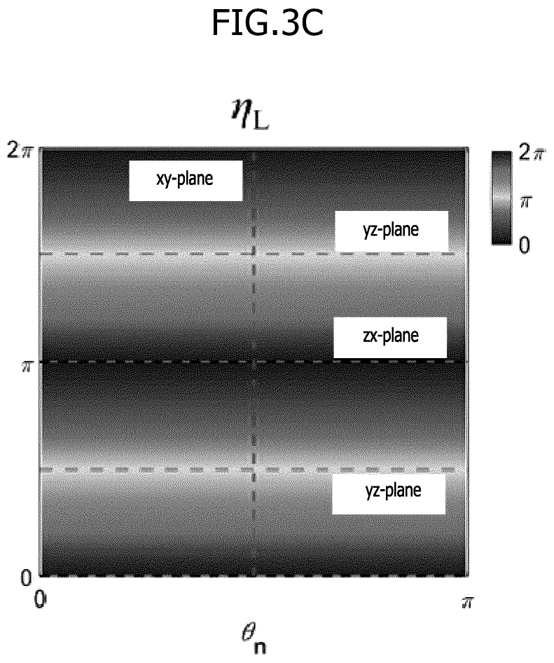

FIG. 3 illustrates a range of an implementable non-abelian gauge field and a phase shift value required therefor. Equation 2 may be expressed by an arbitrary gauge field like Equation 3.

$${U}_{mn} = {σ}_{0} cos \frac{α}{2} ∓ i {σ}_{x} sin {θ}_{n} sin \frac{α}{2} - i {σ}_{z} cos {θ}_{n} sin \frac{α}{2} \qquad [ Equation 3 ]$$

In this case, a value in FIG. 3 may be obtained by calculating a rotation angle α (see FIG. 3A), and required phase shift values ξ_{L} (see FIG. 3B) and η_{L} (FIG. 3B) with respect to spherical coordinate representation parameters θₙ and φₙ that define a unitary operation.

Here, a first dotted line 181 indicates a rotation axis n in a yz-plane and indicates a case in which implementation is impossible except for a y-axis and a z-axis.

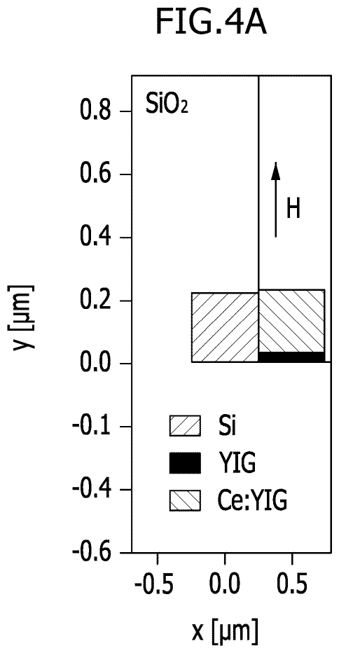

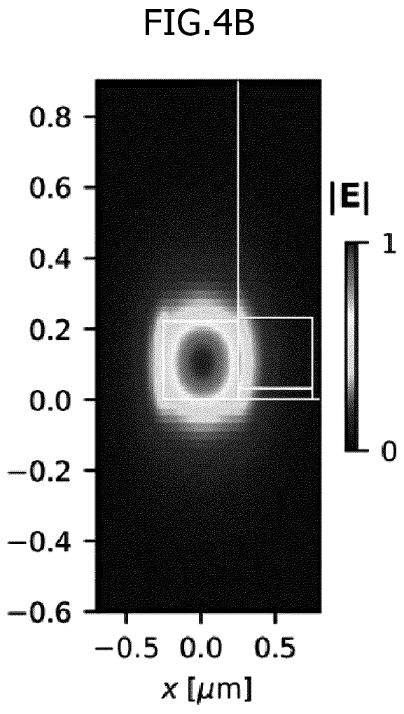

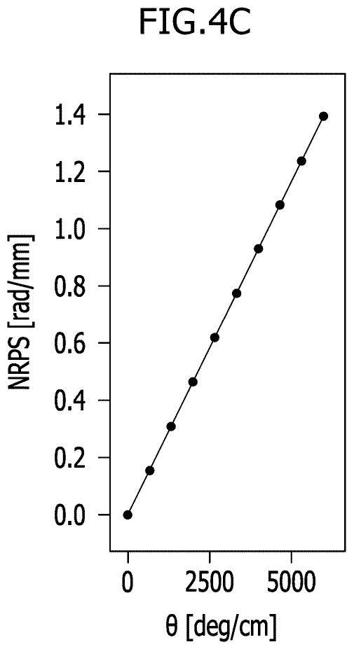

FIG. 4 shows an example of a waveguide design for implementing a non-reciprocal phase shifter.

FIGS. 4B and 4C are cross-sectional views of a non-reciprocal waveguide (see FIG. 4) and an intrinsic mode electric field distribution (see FIG. 4C). An operation at a wavelength of 1,550 nm was assumed, and a non-reciprocal phase shift of a waveguide was calculated through optical mode analysis using a function of a Faraday rotation effect based on a Ce:YIG medium,

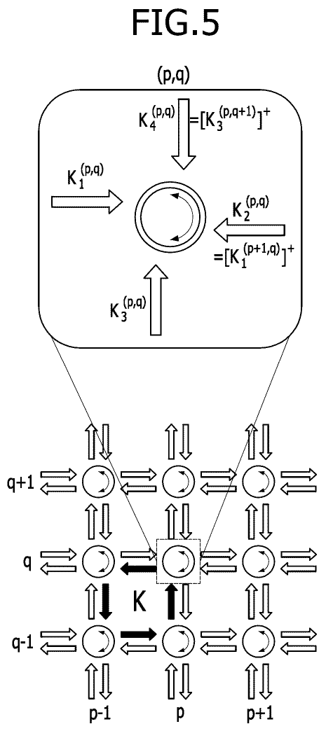

FIG. 5 illustrates a lattice design technique for inducing desired topological characteristics in a lattice implemented based on a unit element according to one embodiment of the present invention. FIG. 5 is a schematic diagram of a distribution of connection variables K_{γ}^{(p,q)} around a (p, q)^{th} unit cell, wherein γ=1, 2, 3, or 4 and indicates a relative direction of a matrix value gauge field. The gauge field may be designed for spatial homogeneity and Hermitian, which allows light in a lattice to experience a non-abelian gauge field with a designed shape.

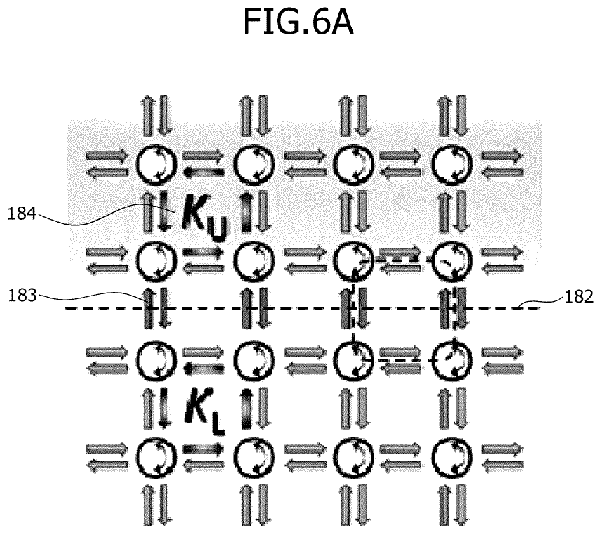

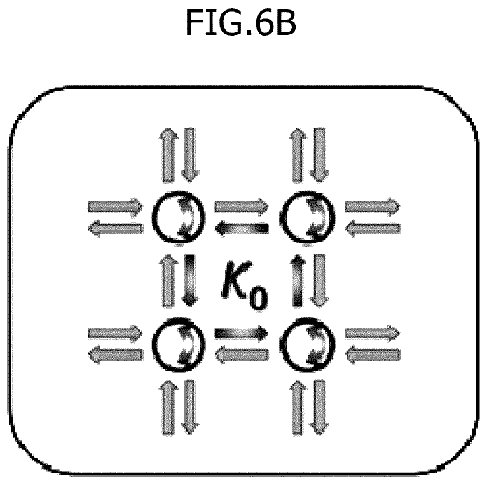

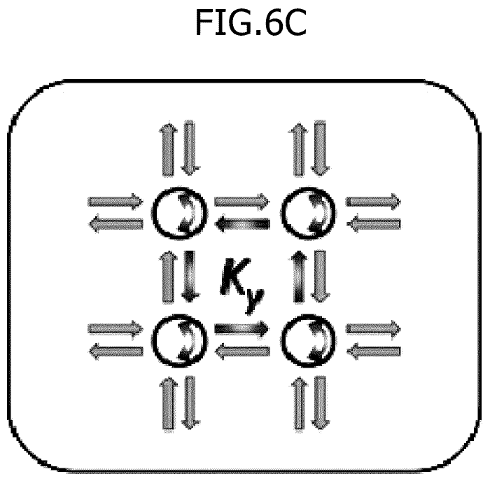

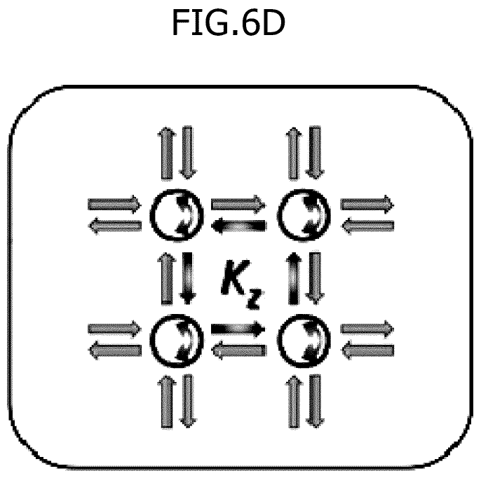

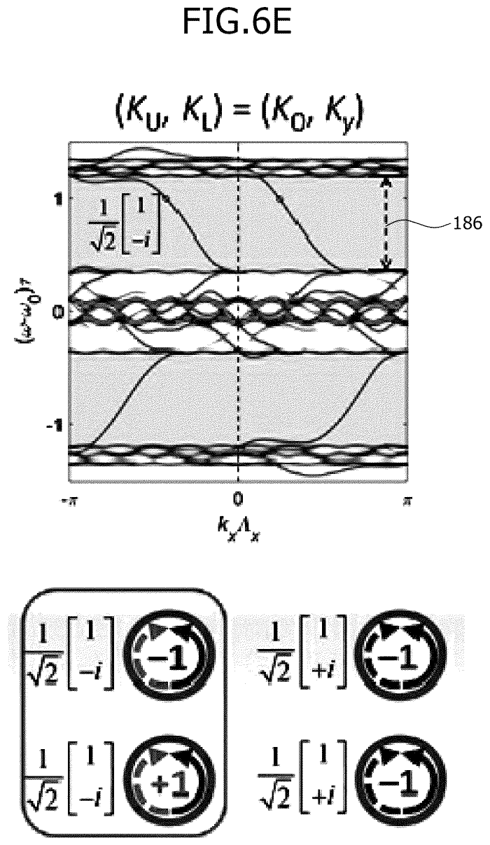

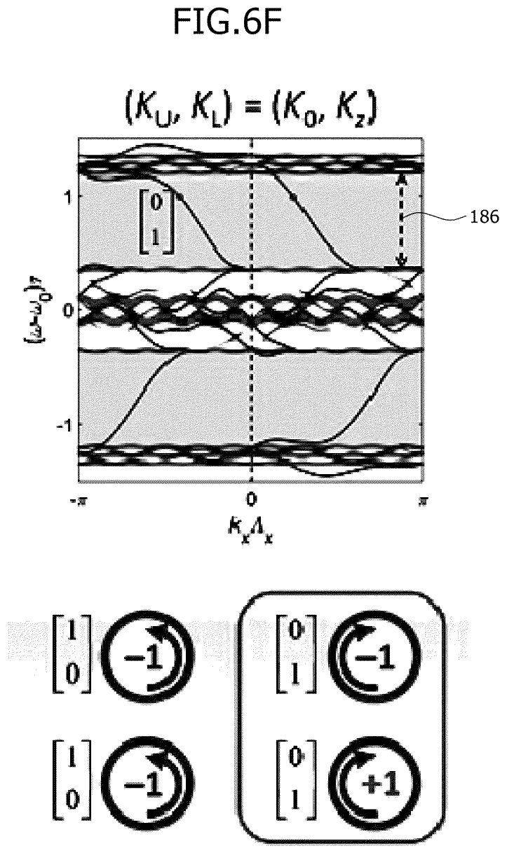

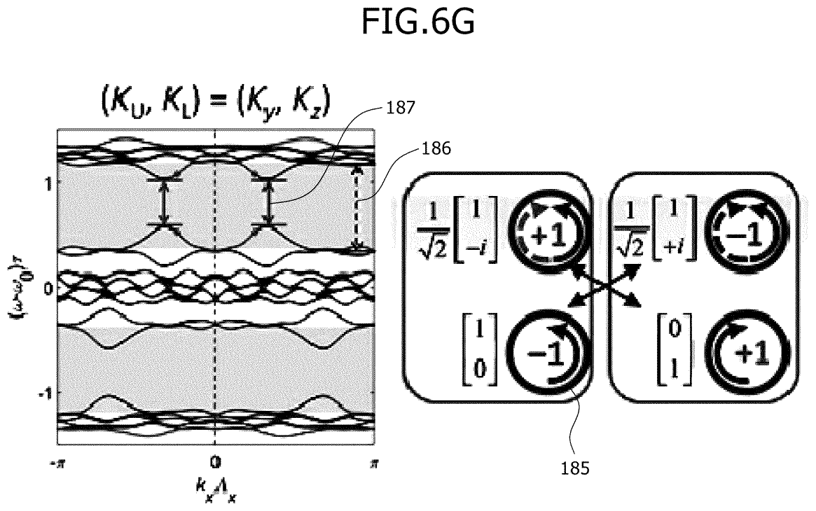

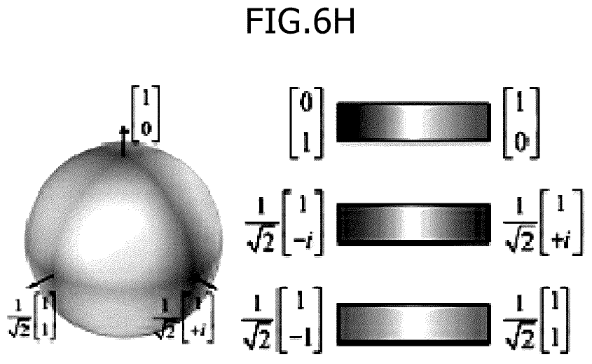

FIG. 6 illustrates various abelian and non-abelian topological medium states implemented through the above-described lattice. Through corresponding results, it is specifically shown that a lattice 10 can implement various optical topological medium states through a non-abelian gauge field implemented in the present embodiment.

FIG. 6A is a schematic diagram of an interface 182 between lattices with loop operators Ku and KL.

FIG. 6A illustrates a coupling 183 with a zero gauge field and an interface loop 184. FIGS. 6B to 6D illustrate topological lattices with loop operators K₀ (see FIG. 6B), K_{y} (see FIG. 6C), and K_{z} (see FIG. 6D). FIGS. 6E to 6G are band diagrams projected onto a kₓ-axis, wherein kₓ denotes an x-component of a reciprocal lattice vector, denotes topologically non-trivial interface configurations corresponding to (K₀, K_{y}) (FIG. 6E) and (K₀, K_{z}) (FIG. 6F) in the case of abelian, and a topologically non-trivial interface configuration corresponding to (K_{y}, K_{z}) (FIG. 6G) in the case of non-abelian. In addition, an intrinsic spinor and a corresponding spin gap number 185 are shown.

FIG. 6H illustrates colormap mixing for representing a spinor basis on a Bloch sphere, wherein the colormap mixing is applied to bands of FIGS. 6E to 6G.

FIGS. 6E to 6G illustrate a band gap 186 of an existing bulk lattice.

In FIG. 6G, the reopening of a band gap 187 is emphasized. A flux applied to each bulk lattice matches a case depicted by a dotted line 186 in the bands of FIG. 6B to 6F, which is characterized by a super lattice of Λₓ=1 and Λ_{y}=10 and a rational flux of μ=0.6π and α/2=0.6π.

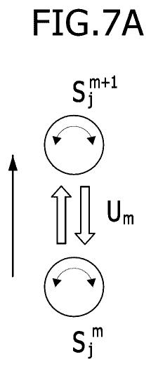

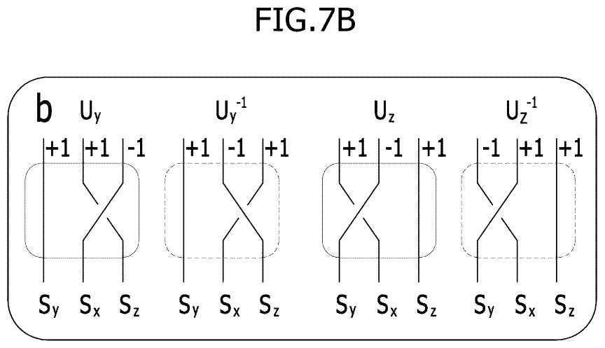

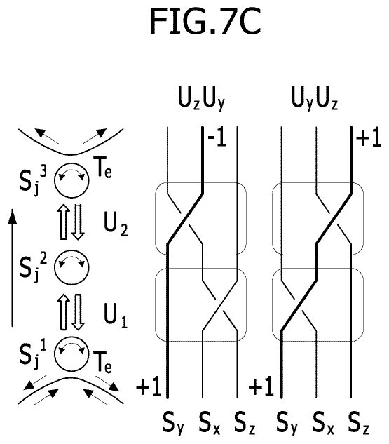

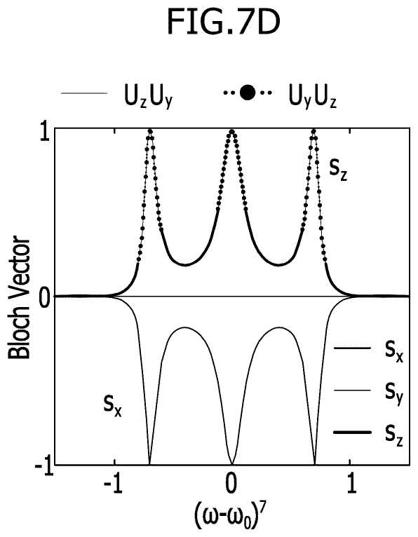

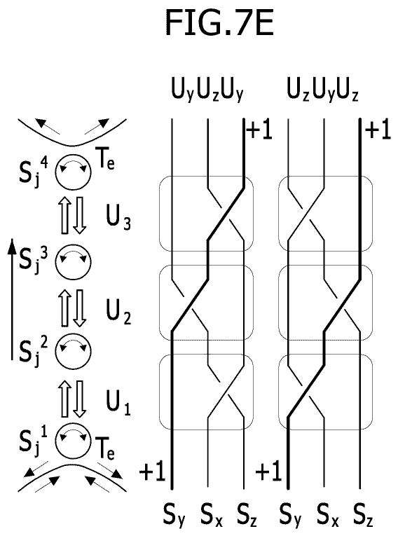

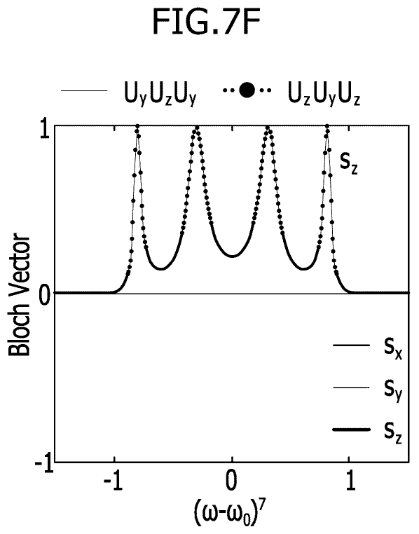

FIG. 7 shows implementation of programmable non-abelian braiding which is essential for a topological quantum computer. A topological state of light may be implemented in a non-abelian braiding form to implement gate operations in topological computing using light.

FIG. 7A illustrates a building block for simulating particle trajectories through a resonator coupling. A pseudospin resonance characterized by spin observability Sⱼₘ in an m^{th} resonator may be coupled through a unitary coupling variable Uₘ consisting of a loop coupler.

FIG. 7B illustrates a constructor for a braiding group B3. A digit ±1 represents a particle state after braiding when Sj is excited to 1.

FIGS. 7C to 7F illustrate non-abelian braiding group criteria. Here, FIGS. 7C and 7D illustrate non-abelian conditions, and FIGS. 7E and 7F illustrate Yang-Baxter relationships. FIGS. 7C and 7E illustrate criteria and a 1D resonator lattice for demonstrating a corresponding braiding operation.

An external waveguide is coupled to a resonator at a boundary with a damping factor of 1/τₑ to excite and measure each of input and output spin observabilities.

In FIGS. 7C and 7D, a case of (U₁,U₂)=(U_{y},U_{z}) is compared with a case of (U₁,U₂)=(U_{z},U_{y}), and in FIGS. 7E and 7F, a case of (U₁,U₂,U₃)=(U_{y},U_{z},U_{y}) is compared with a case of (U₁,U₂,U₃)=(U_{z},U_{y},U_{z}). FIGS. 7D and 7F illustrate the transmission spectra of Bloch vector components through lattices of FIGS. 7C and 7E. In FIGS. 7C to 7F, τₑ=4τ. In FIGS. 7A, 7C, and 7E, a black solid arrow represents an arrow of time.

In this way, a photonic integrated circuit for implementing a non-abelian gauge field according to an embodiment of the present invention induces a non-abelian gauge field through the coupling between lattice elements, thereby constituting reconfigurable abelian and non-abelian topological lattices.

In addition, in a photonic integrated circuit for implementing a non-abelian gauge field according to an embodiment of the present invention, the flow of topologically protected light can be freely controlled, and for example, a state of light rotating in the form of spins in a resonator or a state of light superimposed between spins can be allowed to have strong resistance to noise or defects or a band gap can also be induced in pass frequencies of topologically protected light.

In addition, in a photonic integrated circuit for implementing a non-abelian gauge field according to an embodiment of the present invention, a braiding group required for topological quantum computing is induced for light, thereby enabling a gate operation in which a state of light can be topologically protected. Thus, it is possible to enable the implementation of a unit gate operation of topological quantum computing.

In a photonic integrated circuit for implementing a non-abelian gauge field according to an aspect of the present invention, a non-abelian gauge field is induced when particles constituting an optical lattice are bounded, thereby constituting reconfigurable abelian and non-abelian topological lattices.

In a photonic integrated circuit for implementing a non-abelian gauge field according to an aspect of the present invention, the flow of topologically protected light can be freely controlled, and for example, a state of light rotating in the form of spins in a resonator or a state of light superimposed between spins can be allowed to have strong resistance to noise, or defects or a band gap can also be induced above a pass frequency of topologically protected light.

In a photonic integrated circuit for implementing a non-abelian gauge field according to an aspect of the present invention, a braiding group required for topological quantum computing is induced for light, thereby enabling a gate operation in which a state of light can be topologically protected. Thus, it is possible to enable the implementation of a unit gate operation of topological quantum computing.

The present disclosure has been described with reference to embodiments shown in the drawings, but this is merely illustrative, and those skilled in the art will understand that various modifications and other equivalent embodiments are possible therefrom. Therefore, the true technical protection scope of the present invention should be defined by the appended claims.

What is claimed is:

1. A photonic integrated circuit for implementing a non-abelian gauge field, the photonic integrated circuit comprising:
a unit element including a plurality of resonators; and a waveguide coupler configured to implement a coupling between the resonators,
wherein the waveguide coupler includes a reciprocal phase shifter applied to one single waveguide among waveguides, a local non-reciprocal phase shifter applied to another single waveguide among the waveguides, and a global non-reciprocal phase shifter applied to all of the waveguides.

2. The photonic integrated circuit of claim 1, wherein the reciprocal phase shifter, the local non-reciprocal phase shifter, and the global non-reciprocal phase shifter are formed to have Mach-Zehnder interferometer structures linked to each other in series.

3. The photonic integrated circuit of claim 1, wherein the reciprocal phase shifter is formed to have a waveguide structure including a medium of which a refractive index is controllable.

4. The photonic integrated circuit of claim 1, wherein the reciprocal phase shifter is implemented with thermo-optical, electro-optical, or all-optical modulation.

5. The photonic integrated circuit of claim 1, wherein the local non-reciprocal phase shifter has distinct refractive indices according to a direction.

6. The photonic integrated circuit of claim 5, wherein the local non-reciprocal phase shifter is formed to have a waveguide structure including a non-reciprocal medium of which a refractive index is controllable through a magnetic field.

7. The photonic integrated circuit of claim 1, wherein the global non-reciprocal phase shifter has distinct refractive indices according to a direction.

8. The photonic integrated circuit of claim 7, wherein the global non-reciprocal phase shifter is formed to have a waveguide structure including a non-reciprocal medium of which the refractive index is controllable through a magnetic field.

9. The photonic integrated circuit of claim 1, wherein refractive indices of the reciprocal phase shifter, the local non-reciprocal phase shifter, and the global non-reciprocal phase shifter are designed to implement a matrix expressing a non-abelian gauge field.

10. The photonic integrated circuit of claim 1, wherein the resonator is implemented as a traveling-wave resonator.

11. The photonic integrated circuit of claim 10, wherein the traveling-wave resonator is a microdisk or a ring resonator.

12. The photonic integrated circuit of claim 1, wherein the resonator has a resonance mode in which the resonator rotates clockwise and counterclockwise near an operating frequency.

13. The photonic integrated circuit of claim 1, wherein the unit element implements a braiding group used in topological quantum computing.
